(19) United States
(12) Patent Application Publication
(10) Pub. No.: US 2026/0241565 A1
(43) Pub. Date: Aug. 20, 2026

(54) ROBOT SYSTEM AND ROBOT CONTROL DEVICE

(71) Applicant: FANUC CORPORATION, Minamitsuru-gun, Yamanashi (JP)

(72) Inventor: Kai SHIMOTSUMA, Minamitsuru-gun, Yamanashi (JP)

(21) Appl. No.: 19/475,334

(22) PCT Filed: Apr. 25, 2023
(86) PCT No.: PCT/JP2023/016340

§ 371 Date: Oct. 14, 2025

(51) Int. Cl. B25J 9/16; B25J 9/00

(52) U.S. Cl. CPC B25J 9/1676; B25J 9/0081

(57) ABSTRACT

The present invention ensures an operator's safety even when an operator, during teaching work, commands a robot to perform an action that would cause entanglement of the operator due to carelessness. This robot system comprises: a robot teaching operation panel provided with communication equipment for acquiring position information; a robot provided with communication equipment for acquiring position information; and a robot control device that uses the robot teaching operation panel and the robot, detects at least the position information of the robot teaching operation panel, and controls an action of the robot on the basis of the position information of the robot teaching operation panel.

### TECHNICAL FIELD

The present disclosure relates to a robot system and a robot control device for ensuring the safety of a worker even when the worker enters a robot operation area.

### BACKGROUND ART

When a robot such as an industrial robot is used, a process of teaching the robot what type of motion the robot will take is necessary. Since the robot moves according to worker's operation, an accident may be caused by carelessness.

Countermeasures against the accident include installation of a safety fence and a sensor that monitors the inside of a certain area.

For example, there has been known a technique in which the position of a person present in the vicinity of a robot is detected, an operation prohibited area is set around the detected position of the person, and the robot is urgently stopped in a case where the robot interferes with the operation prohibited area. For example, see Patent Document 1.

### CITATION LIST

### Patent Document

Patent Document 1: Japanese Unexamined Patent Application, Publication No. 2004-243427

### DISCLOSURE OF THE INVENTION

### Problems to Be Solved by the Invention

Risk avoidance during the teaching operation greatly depends on worker's preparation. That is, even when the technique disclosed in Patent Document 1 is applied, the worker preferably performs the teaching operation from a position at which the safety is ensured, but the process can be performed even within the operation area of the robot, which leads to the possibility of an accident occurring due to carelessness or erroneous operation.

A countermeasure in the form of the safety fence or the sensor can be taken, but it takes time and effort to install/set such a safety fence or sensor.

Entry over the safety fence can easily occur depending on the level of awareness of the worker. The sensor may cause false detection due to dust or dirt.

In the case of a system in which the position of the robot itself changes, a larger area needs to be set.

For these reasons, it has been desired to reliably ensure the safety of the worker even in a case where the worker, during a teaching operation, unintentionally commands the robot to perform an operation that could result in the worker himself/herself being affected by the robot.

### Means for Solving the Problems

(1) One aspect of a robot system of the present disclosure includes a robot teach pendant including communication equipment for acquiring position information, a robot including communication equipment for acquiring position information, and a robot control device configured to detect position information of at least the robot teach pendant using the robot teach pendant and the robot, and control operation of the robot based on the position information of the robot teach pendant.

(2) One aspect of the robot system of the present disclosure includes a plurality of transmitters placed at specified positions, a robot teach pendant including a receiver for acquiring position information, a robot including a receiver for acquiring position information, and a robot control device configured to detect position information of at least the robot teach pendant using the robot teach pendant, the robot, and the plurality of transmitters, and set a restricted area for the robot in the vicinity of the position of the robot teach pendant based on the position information of the robot teach pendant.

(3) One aspect of the robot system of the present disclosure includes a robot teach pendant including communication equipment for acquiring position information, a robot including communication equipment for acquiring position information, and a robot control device configured to set, as a restricted area for the robot, the vicinity of a predetermined distance from the robot teach pendant based on wireless communication between the robot teach pendant and the robot.

(4) One aspect of a robot control device of the present disclosure uses a robot teach pendant and a robot, the robot teach pendant including communication equipment for acquiring position information and the robot including communication equipment for acquiring position information, detects position information of at least the robot teach pendant, and controls operation of the robot based on the position information of the robot teach pendant.

### BRIEF DESCRIPTION OF THE DRAWINGS

FIG. 1 is a diagram showing one example of the configuration of a robot system according to one embodiment;

FIG. 2 is a diagram showing one example of the configuration of functional blocks of a robot teach pendant;

FIG. 3 is a diagram showing one example of the configuration of functional blocks of a robot control device;

FIG. 4 is a flowchart for describing control processing of the robot system; and

FIG. 5 is a flowchart for describing the control processing of the robot system.

### PREFERRED MODE FOR CARRYING OUT THE INVENTION

Hereinafter, a robot system according to one embodiment will be described in detail with reference to the figures.

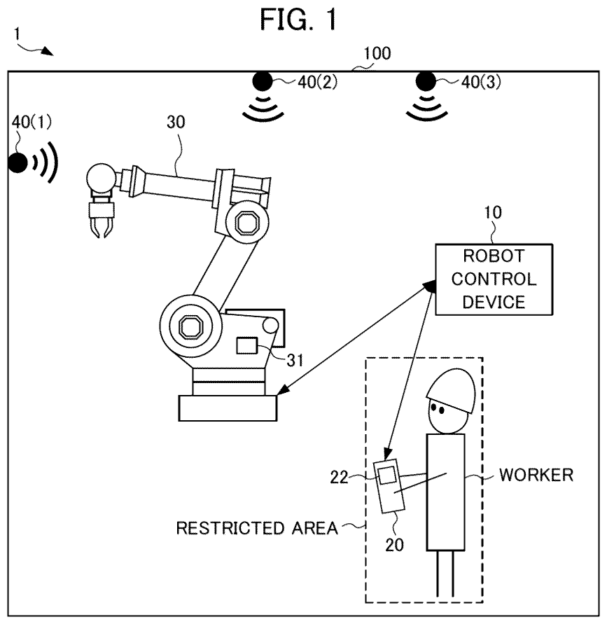

FIG. 1 is a diagram showing one example of the configuration of the robot system according to one embodiment.

As shown in FIG. 1, the robot system 1 has a robot control device 10, a robot teach pendant 20, a robot 30, and transmitters 40(1) to 40(3) disposed in a building 100 such as a factory.

The robot control device 10, the robot teach pendant 20, the robot 30, and the transmitters 40(1) to 40(3) are directly connected to each other via a connection interface (not shown). Note that the robot control device 10, the robot teach pendant 20, the robot 30, and the transmitters 40(1) to 40(3) may be connected to each other via a network (not shown) such as a local area network (LAN) or the Internet to communicate with each other. In this case, the robot control device 10, the robot teach pendant 20, the robot 30, and the transmitters 40(1) to 40(3) include communication units (not shown) for communicating with each other via such connection.

Note that in the description below, the transmitters 40(1) to 40(3) will also be referred to as a “transmitter 40” when not need to be distinguished from each other.

### Transmitter 40

The transmitter 40 is placed, for example, at a specified position on a wall, a ceiling, a column, or the like in the building 100, and transmits a signal, such as a beacon, including unique ID information and the like set to the transmitter 40 with a predetermined intensity set in advance at regular time intervals.

In the present embodiment, three transmitters 40 are disposed, but four or more transmitters 40 may be disposed.

### Robot 30

The robot 30 is a well-known robot that operates based on control by the robot control device 10 described later. The robot 30 has a base for rotating about an axis in the vertical direction, a movable and rotatable arm, and an end effector, such as a hand, attached to the arm.

Further, the robot 30 has a receiver 31. The receiver 31 receives the signal (for example, beacon) transmitted from the transmitter 40, and outputs, to the robot control device 10 described later, the intensity of the signal received from each transmitter 40 or the like as reception data.

Note that in the present embodiment, the robot 30 is disposed at a predetermined position in the building 100 and operates at such a position, but may be equipped with a rail axis and have a self-propelling configuration.

### Robot Teach Pendant 20

The robot teach pendant 20 is a device that teaches the robot 30, and may be a calculator designed only for the robot control device 10 or a calculator such as a tablet type computer.

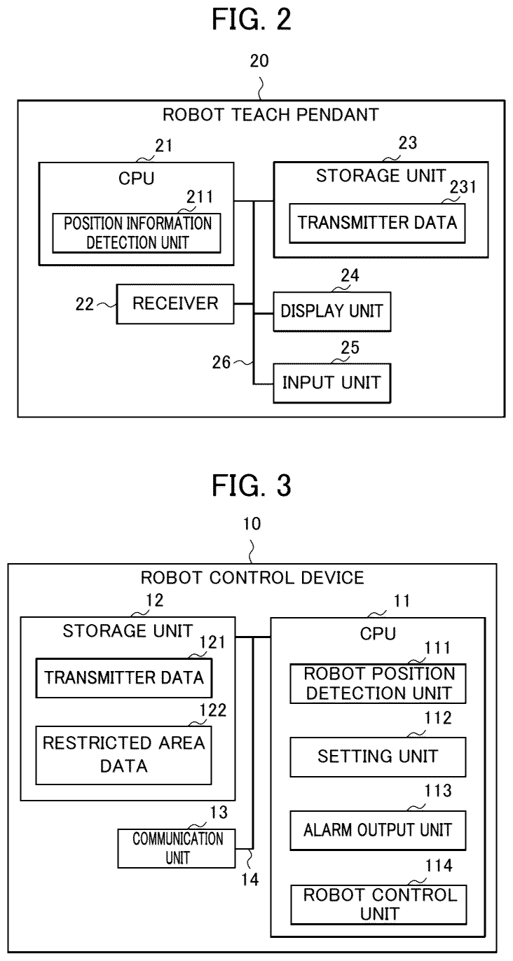

As shown in FIG. 2, the robot teach pendant 20 includes a CPU 21, a receiver 22, a storage unit 23, a display unit 24, an input unit 25, and a bus 26. The CPU 21 includes a position information detection unit 211.

The receiver 22 receives the signal (for example, beacon) transmitted from the transmitter 40. The receiver 22 outputs the intensity of the signal received from each transmitter 40 or the like to the position information detection unit 211 of the CPU 21 described later.

The storage unit 23 is a read only memory (ROM), a solid state drive (SSD), a hard disk drive (HDD), or the like, and stores transmitter data 231.

The transmitter data 231 may include the position at which each transmitter 40 is placed in the building 100, the set transmission intensity of the signal, and the like.

Note that the position of the transmitter 40 may be represented, for example, by a coordinate system with a predetermined position in the building 100 as an origin, latitude and longitude, or the like. A coordinate system of the building 100 and a robot coordinate system of the robot 30 are calibrated in advance.

The display unit 24 is a display device such as a liquid crystal display (LCD), and displays a screen necessary for a teaching operation for the robot 30.

The input unit 25 is, for example, a keyboard, a touch panel disposed on the display unit 24, or the like, and receives input from a worker.

The CPU 21 is a processor that controls the robot teach pendant 20 as a whole. The CPU 21 reads a system program stored in the storage unit 23 and an application program stored in various types of software via the bus 26, and controls the entirety of the robot teach pendant 20 according to the system program and the application program. In this manner, the CPU 21 is configured to implement the function of the position information detection unit 211, as shown in FIG. 2.

The position information detection unit 211 detects (calculates), based on the intensity of the signal of the transmitter 40 received by the receiver 22 and the transmitter data 231, position information indicating the position of the robot teach pendant 20 in the building 100, for example, using a well-known technique such as triangulation. The position information detection unit 211 outputs the detected position information of the robot teach pendant 20 to the robot control device 10.

### Robot Control Device 10

The robot control device 10 is a device well-known by the those skilled in the art for controlling operation of the robot 30. The robot control device 10 generates a control signal by executing an operation program generated using an orthogonal coordinate value or each axis value indicating the position of a tip end point of the robot 30 taught using the robot teach pendant 20 by the worker. The robot control device 10 outputs the generated control signal to the robot 30, thereby operating the robot 30.

As shown in FIG. 3, the robot control device 10 has a CPU 11, a storage unit 12, a communication unit 13, and a bus 14. The CPU 11 has a robot position detection unit 111, a setting unit 112, an alarm output unit 113, and a robot control unit 114.

The storage unit 12 is an SSD, an HDD, or the like, and stores transmitter data 121 and restricted area data 122.

Similarly to the transmitter data 231 of FIG. 2, the transmitter data 121 may include the position at which each transmitter 40 is placed in the building 100, the set transmission intensity of the signal, and the like.

For example, as shown in FIG. 1, the restricted area data 122 may include data regarding the size of a restricted area into which the robot 30 is not allowed to enter in the vicinity of the position of the robot teach pendant 20, which includes at least the worker. Specifically, as shown in FIG. 1, in a case where the restricted area is set to, for example, a rectangular parallelepiped with a size including the worker, the restricted area data 122 may include data indicating the size of such a rectangular parallelepiped. Alternatively, in a case where the restricted area is set to the size of a sphere about the position of the robot teach pendant 20, which includes the worker, the restricted area data 122 may include the size of such a sphere, such as a radius thereof.

Note that in addition to the data on the restricted area, the restricted area data 122 may also include data on a warning area (not shown) outside the restricted area, where the worker who operates the robot teach pendant 20 is warned about the robot 30 approaching the worker.

The communication unit 13 controls, for example, transmission and reception of data between the robot teach pendant 20 and the robot 30.

Specifically, from the robot 30, the communication unit 13 receives, together with data regarding the position and posture of the robot 30, the reception data such as the intensity of the signal received from each transmitter 40 by the receiver 31 of the robot 30. Moreover, the communication unit 13 may output the control signal generated by the robot control device 10 to the robot 30.

Further, from the robot teach pendant 20, the communication unit 13 receives, together with data regarding the taught position of the robot 30, the position information of the robot teach pendant 20. In addition, in a case where the robot 30 approaches the restricted area, the communication unit 13 may output, based on a control instruction from the robot control device 10, an instruction of outputting alarm sound or vibration indicating that the robot 30 has entered the warning area (not shown) outside the restricted area and is approaching the restricted area, to the robot teach pendant 20.

The CPU 11 is a processor that controls the robot control device 10 as a whole. The CPU 11 reads a system program stored in the storage unit 12 and an application program in various types of software via the bus 14, and controls the entirety of the robot control device 10 according to the system program and the application program. In this manner, as shown in FIG. 3, the CPU 11 is configured to implement the functions of the robot position detection unit 111, the setting unit 112, the alarm output unit 113, and the robot control unit 114.

The robot position detection unit 111 detects position information indicating the position of the robot 30 in the building 100 using a well-known technique such as triangulation, for example, based on the intensity of the signal of the transmitter 40 received from the robot 30 via the communication unit 13 and the transmitter data 121.

The setting unit 112 sets the restricted area in the vicinity of the position of the robot teach pendant 20 based on the restricted area data 122 and the position information of the robot teach pendant 20 and the robot 30. Moreover, the setting unit 112 may set the warning area (not shown) outside the restricted area based on the restricted area data 122.

Note that depending on a situation such as a case where the teaching operation using the robot teach pendant 20 by the worker ends or a case where an input of invalidating the setting of the restricted area is received via an input device (not shown) such as a keyboard or a touch panel in the robot control device 10, the setting unit 112 may not set the restricted area.

In this manner, the robot control device 10 can easily switch the setting of the restricted area between enabled and disabled, thereby making it possible to avoid causing an effect of stopping operation of the robot 30 or the like due to false detection or the like, even during runtime execution where a predetermined operation is repeatedly performed by the robot 30 by execution of a robot program after completion of the teaching operation, and the worker does not basically approach the robot 30.

In a case where the robot 30 approaches the restricted area, when the robot 30 enters the warning area (not shown) outside the restricted area, the alarm output unit 113 outputs, to the robot teach pendant 20, an instruction of outputting alarm sound or vibration indicating that the robot 30 is approaching the restricted area.

In this manner, even in a case where the worker, during the teaching operation, unintentionally commands the robot 30 to perform an operation that could result in the worker himself/herself being affected the robot, the robot control device 10 can reliably ensures the safety of the worker.

The robot control unit 114 controls operation of the robot 30 based on the teaching operation with the robot teach pendant 20 by the worker. In a case where the teaching operation by the worker ends and a robot program execution instruction generated based on the taught position is received, the robot control unit 114 controls operation of the robot 30 based on the robot program.

Note that in a case where the robot 30 approaches the restricted area, when the robot 30 enters the warning area (not shown) outside the restricted area and approaches the position of the robot teach pendant 20, the robot control unit 114 may output an instruction of slowing down operation of the robot 30 to the robot 30 via the communication unit 13. Then, the robot control unit 114 may eventually stop the robot 30.

In a case where the robot 30 approaches the restricted area, when the robot 30 enters the warning area (not shown) outside the restricted area and approaches the position of the robot teach pendant 20, the robot control unit 114 may output an instruction of reversing operation of the robot 30 to the robot 30 via the communication unit 13. Then, the robot control unit 114 may eventually stop the robot 30. Note that the “reversing” means, for example, that when the worker commands the robot 30 to move toward the worker himself/herself, when the worker moves toward the direction of operation of the robot 30, or the like, an avoidance operation in an opposite direction is performed.

In a case where the robot 30 approaches the restricted area, when the robot 30 enters the warning area (not shown) outside the restricted area, the robot control unit 114 may output an instruction of operating the robot 30 to bypass the position of the robot teach pendant 20 to the robot 30 via the communication unit 13.

### Control Processing of Robot System 1

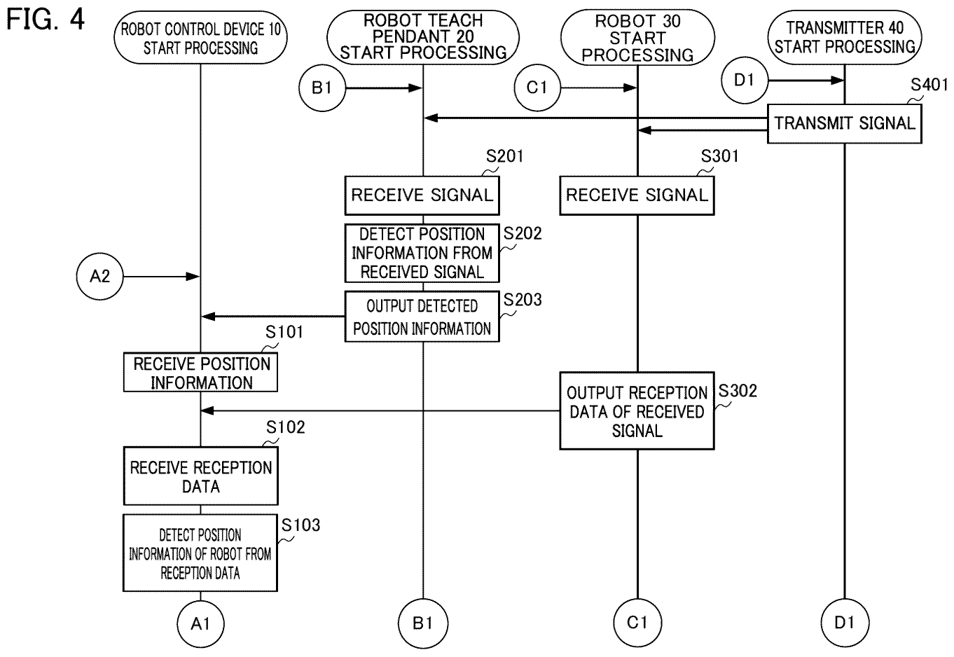

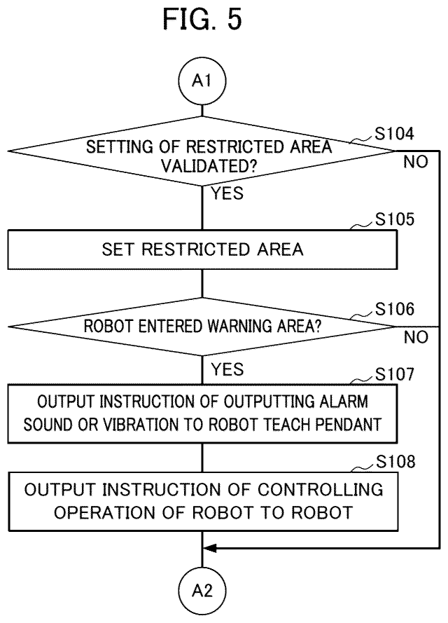

Next, the flow of control processing of the robot system 1 will be described with reference to FIGS. 4 and 5.

FIGS. 4 and 5 are flowcharts for describing the control processing of the robot system 1. The flow described herein is executed every time the teaching operation is performed by the worker.

In Step S401, the transmitter 40 transmits the signal, such as a beacon, including the unique ID information and the like set to the transmitter 40 at the regular time intervals.

In Step S201, the robot teach pendant 20 (receiver 22) receives the signal transmitted in Step S401.

In Step S202, the robot teach pendant 20 (position information detection unit 211) detects (calculates), based on the intensity of the signal of the transmitter 40 received in Step S201 and the transmitter data 231, the position information indicating the position of the robot teach pendant 20 in the building 100.

In Step S203, the robot teach pendant 20 outputs the position information detected in Step S202 to the robot control device 10.

In Step S301, the robot 30 (receiver 31) receives the signal transmitted in Step S401.

In Step S302, the robot 30 outputs, to the robot control device 10, the reception data such as the intensity of the signal of each transmitter 40 received in Step S301.

In Step S101, the robot control device 10 (communication unit 13) receives the position information of the robot teach pendant 20, which is output in Step S203.

In Step S102, the robot control device 10 (communication unit 13) receives the reception data which is output from the robot 30 in Step S302.

In Step S103, the robot control device 10 (robot position detection unit 111) detects, based on the reception data received from the robot 30 and the transmitter data 121, the position information indicating the position of the robot 30 in the building 100.

In Step S104 of FIG. 5, the robot control device 10 (setting unit 112) determines whether or not the setting of the restricted area is validated. In a case where the setting of the restricted area is validated, the processing proceeds to Step S105. On the other hand, in a case where the setting of the restricted area is invalidated, the processing returns to Step S101.

In Step S105, the robot control device 10 (setting unit 112) sets the restricted area in the vicinity of the position of the robot teach pendant 20 based on the restricted area data 122, the position information of the robot teach pendant 20, which is received in Step S101, and the position information of the robot 30, which is detected in Step S103. Moreover, the robot control device 10 (setting unit 112) sets the warning area (not shown) outside the restricted area based on the restricted area data 122.

In Step S106, in a case where the robot 30 approaches the restricted area, the robot control device 10 (alarm output unit 113) determines whether or not the robot 30 has entered the warning area (not shown) outside the restricted area. In a case where the robot 30 has entered the warning area (not shown), the processing proceeds to Step s107. On the other hand, in a case where the robot 30 does not enter the warning area (not shown), the processing returns to Step S101.

In Step S107, the robot control device 10 (alarm output unit 113) outputs an instruction of outputting alarm sound or vibration indicating that the robot 30 is approaching the restricted area to the robot teach pendant 20.

In Step S108, the robot control device 10 (robot control unit 114) outputs an instruction of controlling the robot 30, such as slowing down, reversing, or bypassing operation of the robot 30, to the robot 30 via the communication unit 13.

With the above-described configuration, the robot system 1 according to one embodiment can reliably ensure the safety of the worker even in a case where the worker, during the teaching operation, unintentionally commands the robot to perform an operation that could result in the worker himself/herself being affected by the robot. That is, the robot system 1 sets the restricted area outside an operable area of the robot 30, so that collision can be avoided.

Moreover, the robot system 1 can use the present function without special countermeasure even in the case of a system in which the position of the robot 30 changes.

Further, since the robot system 1 can easily switch the setting of the restricted area between enabled and disabled, it is possible to prevent a negative effect on the robot 30 even in cases such as during runtime execution, in which a predetermined process is repeatedly performed by the robot 30 by execution of the robot program or the like.

### First Modification

In one embodiment, the robot teach pendant 20 detects the position information of the robot teach pendant 20 based on the intensity of the signal received from each transmitter 40 or the like, and outputs the detected position information to the robot control device 10, but the present invention is not limited thereto. For example, similarly to the robot 30, the robot teach pendant 20 may output, to the robot control device 10, the reception data such as the intensity of the signal received from each transmitter 40. In this case, the robot control device 10 may detect, based on the reception data received from the robot teach pendant 20, the position information indicating the position of the robot teach pendant 20.

### Second Modification

Moreover, for example, in the above-described embodiment, the robot teach pendant 20 and the robot 30 have the receiver 22 and the receiver 31 that receive the signal from the transmitter 40, but the present invention is not limited thereto. For example, the robot teach pendant 20 and the robot 30 may include communication equipment capable of performing wireless communication at least between the robot teach pendant 20 and the robot 30. In this case, the robot teach pendant 20 (or the robot 30) may measure the intensity of a signal of wireless communication with the robot 30 (or the robot teach pendant 20) or the like, and output data on the measured signal intensity or the like to the robot control device 10. Then, the robot control device 10 may calculate a relative distance between the robot teach pendant 20 and the robot 30 based on the received signal intensity of the data, and based on the calculated relative distance, set the vicinity of a predetermined distance (for example, 2 m or the like) from the robot teach pendant 20 to the restricted area.

### Third Modification

Further, for example, in the above-described embodiment, the setting unit 112 can enable/disable the setting of the restricted area, but the present invention is not limited thereto. For example, in a case where the setting of the restricted area is invalidated, the setting unit 112 may separately set each of the alarm sound or vibration output from the alarm output unit 113 and operation (for example, stopping, slowing down, bypassing, or the like) of the robot 30 output from the robot control unit 114.

### Fourth Modification

In addition, for example, in the above-described embodiment, the transmitter 40 is disposed in the building 100, but the present invention is not limited thereto. For example, the receiver 22 of the robot teach pendant 20 and the receiver 31 of the robot 30 may be global positioning system (GPS) sensors, and receive a GPS satellite signal to acquire the position information (latitude and longitude) on the robot teach pendant 20 and the robot 30.

Note that each function of the robot system 1 and the robot control device 10 in one embodiment may be implemented by hardware, software, or a combination thereof. Here, implementation by the software means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., flexible disk, magnetic tape, and hard disk drive), magnetic optical recording media (e.g., magnetic optical disk), a CD-read only memory (CD-ROM), a CD-R, a CD-R/W, and semiconductor memories (e.g., mask ROM, programmable ROM (PROM), erasable PROM (EPROM), flash ROM, and RAM). Alternatively, the program may be supplied to the computer by various types of transitory computer readable media. Examples of the transitory computer readable medium include an electric signal, an optical signal, and an electromagnetic wave. The transitory computer readable medium can supply the program to the computer via a wired communication path such as an electric wire or an optical fiber or a wireless communication path.

Note that the steps of describing the program recorded in the recording medium include not only processing performed in chronological order, but also processing executed in parallel or separately. The steps of describing the program may be implemented by cloud computing.

The present disclosure has been described in detail, but is not limited to each of the above-described embodiments. Various additions, replacements, changes, partial omissions, and the like may be made to these embodiments without departing from the gist of the present disclosure or without departing from the gist of the present disclosure derived from the contents described in the claims and the equivalents thereof. These embodiments may be implemented in combination. For example, in the above-described embodiments, the order of each type of operation and the order of each type of processing have been described as an example, and the present disclosure is not limited thereto. The same also applies to numerical values or mathematical expressions if used in the description of the embodiments above.

Further, the following additional remarks will be disclosed regarding the embodiments and modifications above.

### Additional Remark 1

A robot system (1) includes a robot teach pendant (20) including communication equipment for acquiring position information, a robot (30) including communication equipment for acquiring position information, and a robot control device (10) configured to detect position information of at least the robot teach pendant (20) using the robot teach pendant (20) and the robot (30), and control operation of the robot (30) based on the position information of the robot teach pendant (20).

### Additional Remark 2

In the robot system (1) according to Additional Remark 1, the robot control device (10) sets a restricted area for the robot (30) in the vicinity of the position of the robot teach pendant (20).

### Additional Remark 3

A robot system (1) includes a plurality of transmitters (40(1) to 40(3)) placed at specified positions, a robot teach pendant (20) including a receiver (22) for acquiring position information, a robot (30) including a receiver (31) for acquiring position information, and a robot control device (10) configured to detect position information of at least the robot teach pendant (20) using the robot teach pendant (20), the robot (30), and the plurality of transmitters (40(1) to 40(3)), and set a restricted area for the robot (30) in the vicinity of the position of the robot teach pendant (20) based on the position information of the robot teach pendant (20).

### Additional Remark 4

A robot system (1) includes a robot teach pendant (20) including communication equipment for acquiring position information, a robot (30) including communication equipment for acquiring position information, and a robot control device (10) configured to set, as a restricted area for the robot (30), the vicinity of a predetermined distance from the robot teach pendant (20) based on wireless communication between the robot teach pendant (20) and the robot (30).

### Additional Remark 5

In the robot system (1) according to any one of Additional Remarks 2, 3, and 4, the robot control device (10) invalidates the setting of the restricted area for the robot (30) depending on a situation.

### Additional Remark 6

In the robot system (1) according to any one of Additional Remarks 2, 3, and 4, in a case where the robot (30) approaches the restricted area, the robot control device (10) outputs, to the robot teach pendant (20), alarm sound or vibration indicating that the robot (30) is approaching the restricted area.

### Additional Remark 7

In the robot system (1) according to Additional Remark 1, in a case where the robot (30) approaches the position of the robot teach pendant (20), the robot control device (10) slows down operation of the robot (30).

### Additional Remark 8

In the robot system (1) according to Additional Remark 1, in a case where the robot (30) approaches the position of the robot teach pendant (20), the robot control device (10) reverses operation of the robot (30).

### Additional Remark 9

In the robot system (1) according to Additional Remark 1, the robot control device (10) operates the robot (30) to bypass the position of the robot teach pendant (20).

### Additional Remark 10

A robot control device (10) uses a robot teach pendant (20) and a robot (30), the robot teach pendant (20) including communication equipment for acquiring position information and the robot (30) including communication equipment for acquiring position information, detects position information of at least the robot teach pendant (20), and controls operation of the robot (30) based on the position information of the robot teach pendant (20).

### Additional Remark 11

In the robot control device (10) according to Additional Remark 10, the vicinity of the position of the robot teach pendant (20) is set to a restricted area for the robot.

### Additional Remark 12

In the robot control device (10) according to Additional Remark 10 or 11, in a case where the robot (30) approaches the position of the robot teach pendant (20), operation of the robot (30) is slowed down.

### Additional Remark 13

In the robot control device (10) according to Additional Remark 10 or 11, in a case where the robot (30) approaches the position of the robot teach pendant (20), operation of the robot (30) is reversed.

### Additional Remark 14

In the robot control device (10) according to Additional Remark 10 or 11, the robot (30) is operated to bypass the position of the robot teach pendant (20).

### EXPLANATION OF REFERENCE NUMERALS

1 Robot System
10 Robot Control Device
11 CPU
111 Robot Position Detection Unit
112 Setting Unit
113 Alarm Output Unit
114 Robot Control Unit
12 Storage Unit
121 Transmitter Data
122 Restricted Area Data
13 Communication Unit
14 Bus
20 Robot Teach Pendant
21 CPU
211 Position Information Detection Unit
22 Receiver
23 Storage Unit
231 Transmitter Data
24 Display Unit
25 Input Unit
26 Bus
30 Robot
31 Receiver
40(1) to 40(3) Transmitter
100 Building

1. A robot system comprising:
a robot teach pendant including communication equipment for acquiring position information;
a robot including communication equipment for acquiring position information; and
a robot control device configured to detect position information of at least the robot teach pendant using the robot teach pendant and the robot, and control operation of the robot based on the position information of the robot teach pendant.

2. The robot system according to claim 1, wherein the robot control device sets a restricted area for the robot in a vicinity of a position of the robot teach pendant.

3. A robot system comprising:
a plurality of transmitters placed at specified positions;
a robot teach pendant including a receiver for acquiring position information;
a robot including a receiver for acquiring position information; and
a robot control device configured to detect position information of at least the robot teach pendant using the robot teach pendant, the robot, and the plurality of transmitters, and set a restricted area for the robot in a vicinity of a position of the robot teach pendant based on the position information of the robot teach pendant.

4. A robot system comprising:
a robot teach pendant including communication equipment for acquiring position information;
a robot including communication equipment for acquiring position information; and
a robot control device configured to set, as a restricted area for the robot, a vicinity of a predetermined distance from the robot teach pendant based on wireless communication between the robot teach pendant and the robot.

5. The robot system according to claim 2, wherein the robot control device invalidates a setting of the restricted area for the robot depending on a situation.

6. The robot system according to claim 2, wherein in a case where the robot approaches the restricted area, the robot control device outputs, to the robot teach pendant, alarm sound or vibration indicating that the robot is approaching the restricted area.

7. The robot system according to claim 1, wherein in a case where the robot approaches a position of the robot teach pendant, the robot control device slows down operation of the robot.

8. The robot system according to claim 1, wherein in a case where the robot approaches a position of the robot teach pendant, the robot control device reverses operation of the robot.

9. The robot system according to claim 1, wherein the robot control device operates the robot to bypass a position of the robot teach pendant.

10. A robot control device that uses a robot teach pendant and a robot, the robot teach pendant including communication equipment for acquiring position information and the robot including communication equipment for acquiring position information, detects position information of at least the robot teach pendant, and controls operation of the robot based on the position information of the robot teach pendant.

11. The robot control device according to claim 10, wherein a vicinity of a position of the robot teach pendant is set to a restricted area for the robot.

12. The robot control device according to claim 10, wherein in a case where the robot approaches the position of the robot teach pendant, operation of the robot is slowed down.

13. The robot control device according to claim 10, wherein in a case where the robot approaches the position of the robot teach pendant, operation of the robot is reversed.

14. The robot control device according to claim 10, wherein the robot is operated to bypass the position of the robot teach pendant.
